(19) United States
(12) Patent Application Publication
(10) Pub. No.: US 2004/0043902 A1
(43) Pub. Date: Mar. 4, 2004

(54) Heat-sensitive recording material and production method thereof

(76) Inventors: Shigeru Oda, Osaka (JP); Takaaki Mori, Osaka (JP)

Correspondence Address: FROMMER LAWRENCE & HAUG, 745 FIFTH AVENUE- 10TH FL., NEW YORK, NY, 10151, US

(21) Appl. No.: 10/612,142

(22) Filed: Jul. 2, 2003

(30) Foreign Application Priority Data
Sep. 3, 2002 (JP) 2002-257840

(51) Int. Cl. B41M 5/20; B41M 5/24

(52) U.S. Cl. 503/218; 503/213; 503/216; 503/226

(57) ABSTRACT

A heat-sensitive recording material which has a heat-sensitive recording layer formed on a surface of a substrate, the recording layer comprising a basic chromogenic dye precursor and a developer, wherein as the developer, there is used a mixture comprising 5 to 95 wt % of 2,2-dimethyl-1,3-bis(4-hydroxybenzoyloxy)propane and 95 to 5 wt % of 4,4′-hydroxydiphenyl sulfone.

### FIELD OF THE INVENTION

The present invention relates to a heat-sensitive recording material using a thermal color reaction of a basic chromogenic dye precursor with a developer and a production method of the recording material.

### BACKGROUND OF THE INVENTION

A heat-sensitive recording material using a thermal color reaction of a basic chromogenic dye precursor with a developer has been widely applied to a fax, a printer, a label and the like since a system is inexpensive. In particular, as the developer, 2,2-bis(4-hydroxy-phenyl)propane and 4-hydroxy-4′-isopropoxy-diphenyl sulfone are widely known (for example, refer to Japanese Patent Publication No. 54655/1991).

However, heat-sensitive recording materials containing the developers have been required to be further improved with respect to the storage stability of a developed image.

In general, a heat-sensitive recording material having excellent color developability is often liable to have a heavy background fog, and a heat-sensitive recording material having both of the properties in good balance has been desired.

### SUMMARY OF THE INVENTION

An object of the present invention is to provide a heat-sensitive recording material which has excellent initial color developability, has little background fog and can impart excellent recording properties to the storage stability of a recorded image under various conditions and a production method of the recording material.

As a result of making intensive studies, the present inventors have achieved the present invention which is highly sensitive, has little background fog and can impart excellent recording properties to the storage stability of a recorded image by incorporating, as an electron accepting developer, a mixture comprising 5 to 95 wt % of 2,2-dimethyl-1,3-bis(4-hydroxybenzoyloxy)propane and 95 to 5 wt % of 4,4′-hydroxydiphenyl sulfone into a heat-sensitive recording layer using a color development reaction of an electron donating basic chromogenic dye precursor with the developer.

The present invention makes it possible to provide a heat-sensitive recording material which has excellent initial color developability, has little background fog, and is also excellent in color developability and the preservability of a recorded image.

### DETAILED DESCRIPTION OF THE INVENTION

Hereinafter, embodiments of the present invention will be described in detail.

2,2-dimethyl-1,3-bis(4-hydroxybenzoyloxy)propane (for example, refer to Japanese Patent Application Laid-Open No. 64890/1985) or 4,4′-hydroxydiphenyl sulfone as a developer contained in a heat-sensitive recording layer which also contains a basic chromogenic dye precursor is a well-known compound. Each of the two compounds has been used alone. No prior art, however, discloses either the combination of the two compounds including mixing ratios or the effects of the combination.

However, 2,2-dimethyl-1,3-bis(4-hydroxybenzoyloxy)propane has a problem that a recorded image is liable to disappear in a moisture-resistant environment or a heat-resistant environment, while 4,4′-hydroxydiphenyl sulfone, though inexpensive, has problems that it has unsatisfactory color developability, that a recorded image is liable to disappear in a moisture-resistant environment and that a background stains. Thus, it is difficult to use each of these developers alone. However, the present inventors have found that when these compounds are mixed together and used, color developability becomes excellent, a background fog hardly occurs, and an excellent recording property or the storage stability of a recorded image can be imparted to the recorded image. The present inventors have achieved the present invention based on this finding. As for the mixing ratio of the compounds, no effects are seen with respect to color developability and the storage stability of a recorded image when the amount of one of the compounds is exceedingly small as compared with that of the other compound. The proportion of 2,2-dimethyl-1,3-bis(4-hydroxybenzoyloxy)propane to be mixed is 5 to 95 wt %, preferably 25 to 75 wt %.

The term “background fog” as used herein refers to a phenomenon that a background portion that should remain white is colored black by a development procedure or the like.

Further, 4 types of mixing methods are illustrated in order to mix the above compounds together. (1) Each of the two types of compounds may be formed into an aqueous dispersion through the grinding step and contained in a heat-sensitive recording layer at the desired ratio. (2) A powdery mixture of the two types of compounds may be formed into an aqueous dispersion through the grinding step and contained in a heat-sensitive recording layer at the desired ratio. (3) A mixed composition obtained by recrystallization of the two types of compounds using a solvent may be formed into an aqueous dispersion through the grinding step and contained in a heat-sensitive recording layer. (4) A mixed composition is obtained by mixing the two types of compounds together, heating and melting the mixture, and cooling and crystallizing the molten mixture. The mixed composition may be formed into an aqueous dispersion through the grinding step and contained in a heat-sensitive recording layer. These mixing methods are not particularly limited in any way.

Further, to improve the storage stability, color developability and other properties of a thermally recorded image, a phenol-containing compound, a nitrogen-containing compound, a sulfur-containing compound, an urethane-containing compound, an urea-containing compound, a salicylic-acid-containing compound and a compound of a metal salt thereof and the like may be used as developers in such amounts that do not impair the quality of the heat-sensitive recording material, in addition to the above two types of compounds.

Specific examples of the developers include, but are not limited to, 4,4′-isopropylidene bisphenol, 4,4′-cyclohexylidene diphenol, 2,4′-dihydroxyphenyl sulfone, 4-isopropoxy-4′-hydroxydiphenyl sulfone, 4-benzyloxy-4′-hydroxydiphenyl sulfone, 3,3′-dialyl-4,4′-dihydroxydiphenyl sulfone, benzyl p-hydroxybenzoate, a mixture composed essentially of 4,4′-{oxybis(ethyleneoxy-p-phenylenesulfonyl)}diphenol, 4-(2-p-methoxyphenyloxyethoxy)salicylic acid and a zinc salt thereof, 3,5-di(α-methylbenzyl)salicylic acid and a zinc salt thereof, 2,4-bis(phenylsulfonyl)phenol, 2,4-bis(phenylsulfonyl)-5-methylphenol, 4-hydroxybenzene sulfoanilide, a reaction mixture of toluene diisocyanate, diaminodiphenyl sulfone and phenol, 4,4′-bis(p-toluenesulfonylaminocarbonylamino)-diphenylmethane, p-toluenesulfonylamino carboanilide, α-α′-bis{4-(p-hydroxydiphenylsulfone)phenoxy}-p-xylene, and the like.

The developer is preferably supplied in a dispersion state. As a dispersion medium, a dispersant-containing aqueous solution is used. Examples of the dispersant include a sodium polyacrylate, polyvinyl alcohols (varying in the degree of saponification, a pH value and the degree of polymerization), a carboxymethylcellulose, a hydroxyethylcellulose, a polyacrylamide, a starch, and an aluminum salt of a styrene-maleic anhydride copolymer. The developer is ground in the dispersion medium so as to be generally adjusted to have an average particle diameter that is not larger than 5 μm, preferably not larger than 1.5 μm.

As the basic chromogenic dye precursor, at least one selected from the group consisting of 3-N,N-dibutylamino-6-methyl-7-anilinofluoran, 3-N,N-diethylamino-6-methyl-7-anilinofluoran, 3-(N-isoamyl-N-ethyl)amino-6-methyl-7-anilinofluoran, 3-(N-isopentyl-N-ethyl)amino-6-methyl-7-anilinofluoran, 3-(N-cyclohexyl-N-methyl)amino-6-methyl-7-anilinofluoran, 3-N,N-diethylamino-6-chloro-7-anilinofluoran and 3,3-bis(p-dimethylaminophenyl)-6-dimethylaminophthalide is preferably used.

When the amount of the basic chromogenic dye precursor is too small as compared with the amount of the developer, the desired effects cannot be attained, while when the amount is too large, it is uneconomical. Thus, the amount of the basic chromogenic dye precursor is 10 to 500 parts by weight, preferably 20 to 400 parts by weight, more preferably 30 to 200 parts by weight, based on 100 parts by weight of the developer.

The basic chromogenic dye precursor is preferably supplied in a dispersion state. As a dispersion medium, a dispersant-containing aqueous solution is used. Examples of the dispersant include a sodium polyacrylate, polyvinyl alcohols (varying in the degree of saponification, a pH value and the degree of polymerization), a carboxymethylcellulose, a hydroxyethylcellulose, a polyacrylamide, a starch, and an aluminum salt of a styrene-maleic anhydride copolymer. The basic chromogenic dye precursor is ground in the dispersion medium so as to be generally adjusted to have an average particle diameter that is not larger than 5 μm, preferably not larger than 1.5 μm.

Further, as a sensitizer, at least one selected from the group consisting of diphenyl sulfone, 1,2-bis(phenoxy)ethane, 1,2-bis(3-methylphenoxy)ethane, 1,2-bis(4-methylphenoxy)ethane, β-naphthylbenzyl ether, dibenzyl oxalate, di-p-methylbenzyl oxalate, di-p-chlorbenzyl oxalate, stearic acid amide and ethylenebisstearic acid amide is preferably used.

The sensitizer is used in an amount of 10 to 500 parts by weight, preferably 30 to 400 parts by weight, more preferably 50 to 300 parts by weight, based on 100 parts by weight of the developer.

The sensitizer is preferably supplied in a dispersion state. As a dispersion medium, a dispersant-containing aqueous solution is used. Examples of the dispersant include a sodium polyacrylate, polyvinyl alcohols (varying in the degree of saponification, a pH value and the degree of polymerization), a carboxymethylcellulose, a hydroxyethylcellulose, a polyacrylamide, a starch, and an aluminum salt of a styrene-maleic anhydride copolymer. The sensitizer is ground in the dispersion medium so as to be generally adjusted to have an average particle diameter that is not larger than 5 μm, preferably not larger than 1.5 μm.

A pigment may coexist with a pigment which is generally used in a heat-sensitive recording material, such as inorganic fine powders such as a kaoline, silica, amorphous silica, a calcined kaoline, zinc oxide, calcium carbonate, aluminum hydroxide, magnesium carbonate, titanium oxide, barium sulfate and synthetic aluminum silicate and organic resin fine powders such as a styrene-methacrylic acid copolymer, a polystyrene resin and an urea-formalin resin.

The pigment is preferably used in a dispersion state. As a dispersion medium, water or a sodium hexametaphosphate aqueous solution is used. The pigment is dispersed in the dispersion medium.

The above developer dispersion, basic chromogenic dye precursor, sensitizer dispersion and pigment dispersion and a lubricant dispersion are mixed to prepare a coating solution for a heat-sensitive layer.

If necessary, the following substances are added into the coating solution as appropriate under stirring conditions.

Examples of metallic soap include zinc stearate, calcium stearate, and aluminum stearate.

Examples of wax include natural waxes such as a candelilla wax, a rice wax, a Japan wax, a beeswax, a lanolin, a montan wax, a carnauba wax, a ceresin wax, a paraffin wax, a microcrystalline wax, a beef tallow and a coconut oil; derivatives of natural waxes such as a polyethylene wax, a montan wax, a carnauba wax, a microcrystalline wax, a beef tallow and a coconut oil, stearic acid, and the like; and a Fischer-Tropsch wax. These waxes may be used alone or in admixture.

Examples of a surfactant include an alkali metal salt of sulfosuccinic acid, an alkali metal salt of alkylbenzenesulfonic acid, and a sodium salt of lauryl alcohol sulfate.

Examples of the dispersant include a sodium polyacrylate, polyvinyl alcohols (varying in the degree of saponification, a pH value and the degree of polymerization), a carboxymethylcellulose, a hydroxyethylcellulose, a polyacrylamide, a starch, and an ammonium salt of a styrene-maleic anhydride copolymer.

If necessary, as a water resistance enhancer, 1,1,3-tris(2-methyl-4-hydroxy-5-cyclohexylphenyl)butane, 1,1,3-tris(2-methyl-4-hydroxy-5-t-butylphenyl)butane, 4-benzyloxy-4′-2,3-propoxy-diphenyl sulfone and the like may be used.

In addition, as a light resistance enhancer, a benzotriazole-based ultraviolet absorber such as 2-(2-hydroxy-5-methylphenyl)benzotriazole, 2-(2-hydroxy-3-t-butyl-5-methylphenyl)-5-chloro benzotriazole, 2,2-methylenebis[4-(1,1,3,3-tetramethylbutyl)-6-(2H-benzotriazole-2-yl)phenol] and microcapsuled 2-(2-hydroxy-3-dodecyl-5-methylphenyl)benzotriazole may be used.

The above coating solution for the heat-sensitive recording layer according to the present invention can be produced by a known method, and production thereof does not require use of any special method. An aqueous composition comprising the above mixed composition of the basic chromogenic dye precursor and the developer, the sensitizer, the wax, the pigment, the surfactant such as metallic soap, the antifoaming agent, the dispersant and the like is generally ground and then dispersed to have a particle diameter that is not larger than 5 μm, preferably not larger than 1.5 μm, by such means as a ball mill or a sand mill, whereby the coating solution can be prepared.

Further, the heat-sensitive recording layer can be formed in accordance with a known technique, and a method for forming the recording layer is not particularly limited. For example, the recording layer can be formed by coating the coating solution for the heat-sensitive recording layer on a surface of a substrate by an appropriate coating device such as an air-knife coater, a blade coater, a bar coater, a rod coater, a gravure coater, a curtain coater and a wire bar and drying the coated solution. The amount to be coated of the coating solution is also not particularly limited and is generally 0.5 to 50 g/m², more preferably 1.0 to 20.0 g/m², in terms of its weight when dried on the surface of the substrate. As the substrate, paper, a plastic sheet, synthetic paper or the like is used.

Further, to enhance color sensitivity, a primer coat may be formed. A material of the primer coat primarily comprises a pigment or an organic hollow particle and an adhesive. Examples of the pigment include a calcined kaoline, magnesium carbonate, amorphous silica, aluminum silicate, magnesium silicate, calcium silicate, calcium carbonate, and an urea-formalin resin filler. Examples of the organic hollow particles include homopolymer or copolymer resins of vinyl chloride, vinylidene chloride, vinyl acetate, methyl acrylate, ethyl acrylate, methyl methacrylate, acrylonitrile and styrene. Examples of the adhesive include a gelatin, a casein, a starch and a derivative thereof, a methylcellulose, an ethylcellulose, a hydroxyethylcellulose, a carboxymethylcellulose, a methoxycellulose, water-soluble polymers such as a wholly (partially) saponified polyvinyl alcohol, a carboxy modified polyvinyl alcohol, an acetoacetyl modified polyvinyl alcohol, a silicon modified polyvinyl alcohol, an allylamide-ethyl acrylate copolymer and a styrene-maleic anhydride copolymer, and hydrophobic polymers such as a styrene-butadiene resin, a styrene-acrylic resin, a vinyl acetate resin and an acrylic resin. Further, formation of the primer coat is not particularly limited. For example, the primer coat can be formed in the same manner as the foregoing heat-sensitive recording layer is formed.

Further, to improve preservability and the like as well, a protective layer may be formed on the surface of the heat-sensitive recording layer and, as required, on the back of the substrate. The protective layer contains an adhesive having film formability, a pigment and the like as main components and may also contain an ultraviolet absorber and the like as required.

Examples of the adhesive having film formability include a carboxy-modified polyvinyl alcohol, an acetoacetyl-modified polyvinyl alcohol, a silicon-modified polyvinyl alcohol and a diacetone-modified polyvinyl alcohol. Meanwhile, as the pigment and the ultraviolet absorber, those mentioned above with respect to the heat-sensitive recording layer may be used.

Formation of the protective layer is also not particularly limited. For example, the protective layer can be formed in the same manner as the foregoing heat-sensitive recording layer is formed.

Further, in the heat-sensitive recording material of the present invention, it is also possible to form an adhesive layer composed essentially of natural rubber, an acrylic resin based adhesive, a styrene isoprene block copolymer and a two-pack-crosslinked acrylic-resin-based adhesive on the back of the substrate or on the surface of the protective layer or carry out smoothing such as supercalendering after formation of the above layers.

Hereinafter, the present invention will be described in more detail with reference to specific examples.

### EXAMPLE 1

<Preparation of Coating Solution for Primer Coat>

80 g of calcined kaoline (trade name: ANCYLEX, product of EC CO., LTD.), 20 g of calcium carbonate (trade name: UNIBAR 70, product of SHIRAISHI KOGYO CO., LTD.), 140 g of 5% aqueous solution of polyvinyl alcohol (trade name: PVA-117, product of KURARAY CO., LTD.), 15 g of 48% styrene-butadiene latex, 2 g of 20% aqueous solution of sodium polyacrylate and 30 g of water were mixed together and stirred so as to obtain a coating solution for a primer coat.

<Preparation of Coating Solution for Heat-Sensitive Layer>

(Preparation of Developer Dispersion)

A mixture of 21 g of 2,2-dimethyl-1,3-bis(4-hydroxybenzoyloxy)propane and 9 g of 4,4′-hydroxydiphenyl sulfone was ground in 70 g of 5% aqueous solution of methylcellulose (trade name: METHLOSE 60SH-03, product of SHIN-ETSU CHEMICAL CO., LTD.) by use of a sand grinder (TSG4H, product of IGARASHI KIKAI CO., LTD.) so as to prepare an aqueous dispersion having an average particle diameter of 1.0 μm.

(Preparation of Basic Chromogenic Dye Precursor Dispersion)

30 g of 3-N,N-dibutylamino-6-methyl-7-anilinofluoran was ground in 70 g of 5% aqueous solution of PVA-117 by use of a sand grinder so as to prepare an aqueous dispersion having an average particle diameter of 1.0 μm.

(Preparation of Sensitizer Dispersion) 30 g of 1,2-bis(3-methylphenoxy)ethane was ground in 70 g of 5% aqueous solution of PVA-117 by use of a sand grinder so as to prepare an aqueous dispersion having an average particle diameter of 1.0 μm.

(Preparation of Pigment Dispersion)

30 g of UNIBAR 70, 69 g of water and 1.0 g of 40% aqueous solution of sodium hexametaphosphate were stirred by use of a homo-disperser (TK HOMODISPER model L, product of TOKUSHU KIKA KOGYO CO., LTD.) at 5,000 rpm for 5 minutes so as to prepare a pigment dispersion.

7.2 g of the developer dispersion, 3.6 g of the basic chromogenic dye precursor dispersion, 7.2 g of the sensitizer dispersion, 7.2 g of the pigment dispersion and 1.8 g of HYDRIN Z-7 (trade name of product of CHUKYO YUSHI CO., LTD.) with a concentration of zinc stearate emulsion of 30% as a lubricant dispersion were used, and then 21.6 g of 5% PVA-117 aqueous solution was mixed thereinto so as to obtain a coating solution for a heat-sensitive recording layer.

(Preparation of Heat-Sensitive Recording Material)

On one surface of high-quality neutral paper of 64 g/m², the coating solution for a primer coat and the coating solution for a heat-sensitive layer were in turn coated by use of a wire bar such that the amount of the coating solution for a primer coat and the amount of the coating solution for a heat-sensitive layer after drying would be 10 g/m² and 3 g/m², respectively, and the coated solutions were then dried so as to obtain a heat-sensitive recording material. After formation of the foregoing layers, supercalendering was carried out.

### EXAMPLES 2 TO 8 AND COMPARATIVE EXAMPLES 1 TO 6

As Examples 2 to 8 and Comparative Examples 1 to 6, heat-sensitive recording materials were prepared in the same manner as in Example 1 except that the combination of the developer, the basic chromogenic dye precursor and the sensitizer was changed to the following combinations.

### EXAMPLE 2

Developer: 2,2-dimethyl-1,3-bis(4-hydroxybenzoyloxy)propane: 4,4′-hydroxydiphenyl sulfone=90:10

Basic Chromogenic Dye Precursor: 3-N,N-dibutylamino-6-methyl-7-anilinofluoran

Sensitizer: 1,2-bis(3-methylphenoxy)ethane

### EXAMPLE 3

Developer: 2,2-dimethyl-1,3-bis(4-hydroxybenzoyloxy)propane: 4,4′-hydroxydiphenyl sulfone=50:50

Basic Chromogenic Dye Precursor: 3-N,N-dibutylamino-6-methyl-7-anilinofluoran

Sensitizer: 1,2-bis(3-methylphenoxy)ethane

### EXAMPLE 4

Developer: 2,2-dimethyl-1,3-bis(4-hydroxybenzoyloxy)propane: 4,4′-hydroxydiphenyl sulfone=30:70

Basic Chromogenic Dye Precursor: 3-N,N-dibutylamino-6-methyl-7-anilinofluoran

Sensitizer: 1,2-bis(3-methylphenoxy)ethane

### EXAMPLE 5

Developer: 2,2-dimethyl-1,3-bis(4-hydroxybenzoyloxy)propane: 4,4′-hydroxydiphenyl sulfone=50:50

Basic Chromogenic Dye Precursor: 3-N,N-dibutylamino-6-methyl-7-anilinofluoran

Sensitizer: β-naphthylbenzyl ether

### EXAMPLE 6

Developer: 2,2-dimethyl-1,3-bis(4-hydroxybenzoyloxy)propane: 4,4′-hydroxydiphenyl sulfone=50:50

Basic Chromogenic Dye Precursor: 3-N,N-dibutylamino-6-methyl-7-anilinofluoran

Sensitizer: di-p-methylbenzyl oxalate

### EXAMPLE 7

Developer: 2,2-dimethyl-1,3-bis(4-hydroxybenzoyloxy)propane: 4,4′-hydroxydiphenyl sulfone=50:50

Basic Chromogenic Dye Precursor: 3-N,N-dibutylamino-6-methyl-7-anilinofluoran

Sensitizer: 1,2-bis(3-methylphenoxy)ethane: stearic acid amide=1:1

### EXAMPLE 8

Developer: 2,2-dimethyl-1,3-bis(4-hydroxybenzoyloxy)propane: 4,4′-hydroxydiphenyl sulfone=50:50

Basic Chromogenic Dye Precursor: 3-(N-isoamyl-N-ethyl)amino-6-methyl-7-anilinofluoran

Sensitizer: 1,2-bis(3-methylphenoxy)ethane

### COMPARATIVE EXAMPLE 1

Developer: 4-hydroxy-4′-isopropoxy-diphenyl sulfone

Basic Chromogenic Dye Precursor: 3-N,N-dibutylamino-6-methyl-7-anilinofluoran

Sensitizer: 1,2-bis(3-methylphenoxy)ethane

### COMPARATIVE EXAMPLE 2

Developer: 2,2-bis(4-hydroxy-phenyl)propane

Basic Chromogenic Dye Precursor: 3-N,N-dibutylamino-6-methyl-7-anilinofluoran

Sensitizer: 1,2-bis(3-methylphenoxy)ethane

### COMPARATIVE EXAMPLE 3

Developer: 2,2-dimethyl-1,3-bis(4-hydroxybenzoyloxy)propane

Basic Chromogenic Dye Precursor: 3-N,N-dibutylamino-6-methyl-7-anilinofluoran

Sensitizer: 1,2-bis(3-methylphenoxy)ethane

### COMPARATIVE EXAMPLE 4

Developer: 4,4′-hydroxydiphenyl sulfone

Basic Chromogenic Dye Precursor: 3-N,N-dibutylamino-6-methyl-7-anilinofluoran

Sensitizer: 1,2-bis(3-methylphenoxy)ethane

### COMPARATIVE EXAMPLE 5

Developer: 4-hydroxy-4′-isopropoxy-diphenyl sulfone

Basic Chromogenic Dye Precursor: 3-(N-isoamyl-N-ethyl)amino-6-methyl-7-anilinofluoran

Sensitizer: 1,2-bis(3-methylphenoxy)ethane

### COMPARATIVE EXAMPLE 6

Developer: 1,1-bis(4-hydroxybenzoyloxy)methane: 4,4′-hydroxydiphenyl sulfone=50:50

Basic Chromogenic Dye Precursor: 3-(N-isoamyl-N-ethyl)amino-6-methyl-7-anilinofluoran

Sensitizer: 1,2-bis(3-methylphenoxy)ethane

Then, the heat-sensitive recording papers obtained in Examples 1 to 8 and Comparative Examples 1 to 6 were subjected to a print test. A heat-sensitive paper color development testing device <TH-PMD> (product of OHKURA ELECTRIC CO., LTD.) with a heat-sensitive head (KYOCERA, TYPE KJT-256-8MGFI-ASH) of 1653 Ω was used at a print voltage of 24V and print cycles of 0.7 msec and 1.4 msec to carry out the following performance tests. The results are shown in Table 1.

<Performance Comparison Tests>

(1) Background Optical Density and Print Density

These were measured by use of a Macbeth densitometer (model RD-918, product of Macbeth Co., Ltd.).

(2) Moisture-Resistant Test

The heat-sensitive recording paper was left to stand at a temperature of 45° C. and a humidity of 85% for 24 hours. Then, a background fog and a print density were measured by use of a Macbeth densitometer.

(3) Heat-Resistant Test

The heat-sensitive recording paper was left to stand at a temperature of 60° C. for 24 hours. Then, a background fog and a print density were measured by use of a Macbeth densitometer.

(4) Water-Resistant Test

The heat-sensitive recording paper was immersed in water at a temperature of 25° C. for 1 hour. Then a print density was measured by use of a Macbeth densitometer.

(5) Anti-plasticizer Test

The print paper was wound around a glass bottle, and then HIRAP V-450 (trade name, product of MITSUI TOATSU KAGAKU CO., LTD.) was wound therearound for 3 turns. Then, after the resulting bottle was left to stand at 25° C. for 15 minutes, a print density was measured by use of a Macbeth densitometer.

TABLE 1

| | | | Moisture | | | | | Resistance |
|---|---|---|---|---|---|---|---|---|
| | Initial | | Resistance | | Heat Resistance | | Water | to |
| | Back- | | Back- | | Back- | | Resistance | Plasticizer |
| | ground | Print | ground | Print | ground | Print | Print | Print |
| | Fog | Density | Fog | Density | Fog | Density | Density | Density |
| Ex. 1 | 0.04 | 1.42 | 0.04 | 1.37 | 0.08 | 1.40 | 1.12 | 1.27 |
| Ex. 2 | 0.04 | 1.40 | 0.04 | 1.35 | 0.07 | 1.39 | 1.12 | 1.25 |
| Ex. 3 | 0.04 | 1.41 | 0.04 | 1.37 | 0.08 | 1.39 | 1.12 | 1.24 |
| Ex. 4 | 0.04 | 1.40 | 0.04 | 1.36 | 0.08 | 1.38 | 1.12 | 1.24 |
| Ex. 5 | 0.04 | 1.40 | 0.04 | 1.36 | 0.08 | 1.38 | 1.11 | 1.23 |
| Ex. 6 | 0.04 | 1.40 | 0.04 | 1.36 | 0.08 | 1.38 | 1.11 | 1.23 |
| Ex. 7 | 0.04 | 1.42 | 0.04 | 1.33 | 0.06 | 1.35 | 1.06 | 1.22 |
| Ex. 8 | 0.05 | 1.41 | 0.05 | 1.38 | 0.09 | 1.40 | 1.12 | 1.26 |
| C. Ex. 1 | 0.04 | 1.32 | 0.04 | 1.27 | 0.08 | 1.23 | 0.96 | 1.08 |
| C. Ex. 2 | 0.05 | 1.40 | 0.05 | 1.20 | 0.10 | 1.18 | 0.60 | 0.30 |
| C. Ex. 3 | 0.04 | 1.38 | 0.04 | 1.07 | 0.09 | 1.18 | 1.05 | 1.05 |
| C. Ex. 4 | 0.04 | 1.20 | 0.05 | 1.05 | 0.08 | 1.10 | 0.90 | 1.00 |
| C. Ex. 5 | 0.05 | 1.32 | 0.05 | 1.28 | 0.07 | 1.26 | 0.98 | 1.10 |
| C. Ex. 6 | 0.04 | 1.20 | 0.04 | 1.06 | 0.08 | 1.12 | 1.05 | 0.95 |

Ex.: Example,
C. Ex.: Comparative Example

It is understood from Table 1 that the heat-sensitive recording materials of the present invention have excellent initial color developability, that since the levels of background fog thereof are the same as those of Comparative Examples (existing products), deterioration of the background fog along with an improvement in color developability is hardly seen and that the heat-sensitive recording materials of the present invention are well-balanced heat-sensitive recording materials which are excellent in the preservability of a recorded image.

What is claimed is:

1. A heat-sensitive recording material which has a heat-sensitive recording layer formed on a surface of a substrate, the recording layer comprising a basic chromogenic dye precursor and a developer, wherein as the developer, there is used a mixture comprising 5 to 95 wt % of 2,2-dimethyl-1,3-bis(4-hydroxybenzoyloxy)propane and 95 to 5 wt % of 4,4′-hydroxydiphenyl sulfone.

2. The material according to claim 1, wherein as the developer, there is used a mixture comprising 25 to 75 wt % of 2,2-dimethyl-1,3-bis(4-hydroxybenzoyloxy)propane and 75 to 25 wt % of 4,4′-hydroxydiphenyl sulfone.

3. The material according to claim 1, wherein the heat-sensitive recording layer contains, as the basic chromogenic dye precursor, at least one selected from the group consisting of 3-N,N-dibutylamino-6-methyl-7-anilinofluoran, 3-N,N-diethylamino-6-methyl-7-anilinofluoran, 3-(N-isoamyl-N-ethyl)amino-6-methyl-7-anilinofluoran, 3-(N-isopentyl-N-ethyl)amino-6-methyl-7-anilinofluoran, 3-(N-cyclohexyl-N-methyl)amino-6-methyl-7-anilinofluoran, 3-N,N-diethylamino-6-chloro-7-anilinofluoran and 3,3-bis(p-dimethylaminophenyl)-6-dimethylaminophthalide.

4. The material according to claim 1, wherein the heat-sensitive recording layer contains, as a sensitizer, at least one selected from the group consisting of diphenyl sulfone, 1,2-bis(phenoxy)ethane, 1,2-bis(3-methylphenoxy)ethane, 1,2-bis(4-methylphenoxy)ethane, β-naphthylbenzyl ether, dibenzyl oxalate, di-p-methylbenzyl oxalate, di-p-chlorbenzyl oxalate, stearic acid amide and ethylenebisstearic acid amide.

5. The material according to claim 2, wherein the heat-sensitive recording layer contains, as a sensitizer, at least one selected from the group consisting of diphenyl sulfone, 1,2-bis(phenoxy)ethane, 1,2-bis(3-methylphenoxy)ethane, 1,2-bis(4-methylphenoxy)ethane, ρnaphthylbenzyl ether, dibenzyl oxalate, di-p-methylbenzyl oxalate, di-p-chlorbenzyl oxalate, stearic acid amide and ethylenebisstearic acid amide.

6. A method for producing a heat-sensitive recording material which comprises the steps of applying a coating solution for a primer coat on one surface of a substrate and then applying a coating solution for a heat-sensitive layer on the formed primer coat, wherein the coating solution for a heat-sensitive layer is prepared by mixing of a developer dispersion, a basic chromogenic dye precursor dispersion, a sensitizer dispersion, a pigment dispersion and a lubricant dispersion, and the developer is a mixture of 2,2-dimethyl-1,3-bis(4-hydroxybenzoyloxy)propane and 4,4′-hydroxydiphenyl sulfone.

7. A method for producing a heat-sensitive recording material which comprises the steps of applying a coating solution for a primer coat on one surface of a substrate and then applying a coating solution for a heat-sensitive layer on the formed primer coat, wherein the coating solution for a heat-sensitive layer is prepared by mixing of a developer dispersion, a basic chromogenic dye precursor dispersion, a sensitizer dispersion, a pigment dispersion and a lubricant dispersion, and the sensitizer is selected from the group consisting of 1,2-bis(phenoxy)ethane, 1,2-bis(3-methylphenoxy)ethane, ρ-naphthylbenzyl ether and stearic acid amide.
